(19) United States
(12) Patent Application Publication
(10) Pub. No.: US 2002/0024428 A1
(43) Pub. Date: Feb. 28, 2002

(54) Vehicle immobilizer with additional functions

(75) Inventors: Patrick A. Banas, Sterling Heights, MI (US); James A. Poirier, Sterling Heights, MI (US)

Correspondence Address: LAURA M. SLENZAK, SIEMENS CORPORATION, 186 WOOD AVENUE SOUTH, ISELIN, NJ, 08830, US

(73) Assignee: Siemens Automotive Corporation

(21) Appl. No.: 09/934,056

(22) Filed: Aug. 21, 2001

Related U.S. Application Data
(60) Provisional application No. 60/227,539, filed on Aug. 24, 2000.

(51) Int. Cl. B60R 25/10

(52) U.S. Cl. 340/426; 307/10.2

(57) ABSTRACT

An improved immobilizer system for a vehicle utilizes the immobilizer key to provide a signal to the immobilizer control that is utilized to control a vehicle function in addition to the immobilizer. In one embodiment the additional function is the detection of a key in the ignition. Thus, should a vehicle door open, or some other change in status occur, the control determines whether the key is still in the ignition. If so, a warning signal is sent. Other uses of determining whether a key is still in the ignition will also come within the scope of this embodiment. In a second feature, the identification code on the key is utilized to provide an indication of a particular user such that a memory position can be recalled based upon the particular user.

This application claims priority to U.S. Provisional Patent Application Ser. No. 60/227,539, filed Aug. 24, 2000.

### BACKGROUND OF THE INVENTION

Modem vehicles are often provided with an immobilizer system which ensures an appropriate vehicle key is in an ignition lock prior to allowing the vehicle to start. This type of system typically assigns a unique code to each key. A control for the immobilizer system a programmed to the code for keys which have been assigned for the particular vehicle. With such systems, when an attempt is made to start the vehicle, the control queries the key to determine its code. If the appropriate code is not provided, then ignition is either refused or terminated.

The communications generally occur at an LF band.

The programming of the key and the provision of the code provides the opportunity to achieve functions other than the immobilizer function. However, to date, only the immobilizer function has utilized this coded key.

### SUMMARY OF THE INVENTION

In a disclosed embodiment of this invention the immobilizer key and code is utilized to provide a function in addition to the immobilizer function. In the prior art, the receiver and transmitter on the key receives a query from the immobilizer control when a key is placed in the ignition. The present invention queries the key when a change in status, such as the door being opened, is received. If a key signal is received by the immobilizer control, then the determination is made that the key is still in the ignition while the door is being opened. A warning signal can then be sounded. With this embodiment, the key switch which is typically incorporated into the ignition and provides a warning function, can be eliminated. Other controls based on the presence or lack thereof of the key can also be provided with this function. Again, this allows the key switch to be eliminated.

In a second feature, the immobilizer key code can be utilized to request the vehicle to move components to a “memory” position for the particular user of the key. Memory systems are known wherein a control receives a signal which activates several components on the vehicle (i.e., vehicle seats, mirrors, etc.) to move to previously preset positions. Typically, the memory function has required the actuation of a memory switch assigned one of a few numbers. However, utilizing the immobilizer function eliminates the requirement of separate memory switches. While this function has been provided with remote keyless entry systems, it has typically not been incorporated into a key having an immobilizer code.

These and other features of the present invention can be best understood from the following specification and drawings, the following of which is a brief description.

### BRIEF DESCRIPTION OF THE DRAWINGS

FIG. 1 is a schematic view of an immobilizer system providing additional control functions.

### DETAILED DESCRIPTION OF A PREFERRED EMBODIMENT

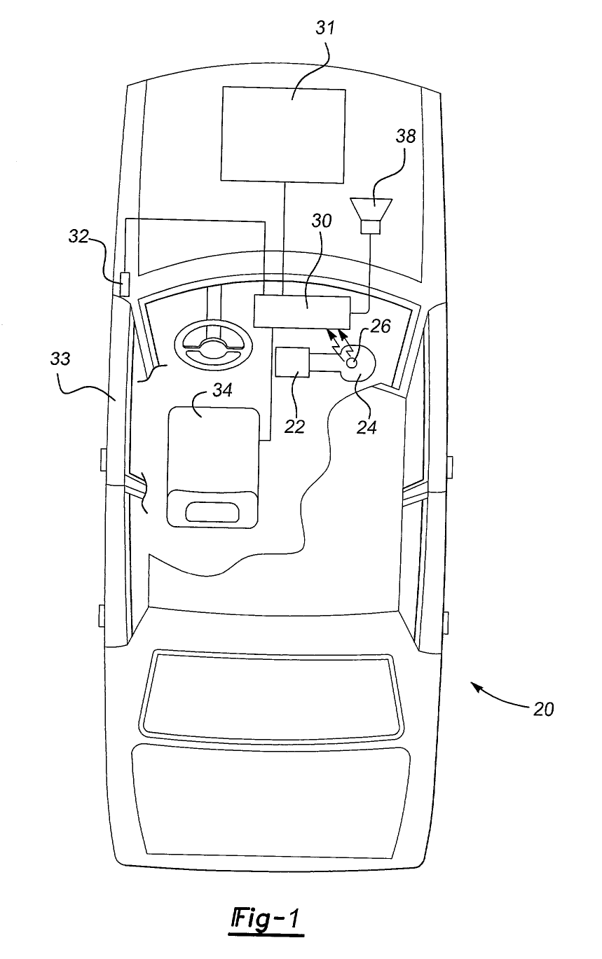

A vehicle 20 is illustrated in FIG. 1 having an ignition lock 22 with an ignition key 24 received in the lock. As is known, the key 24 is provided with a transmitter/receiver 26 which can transmit a coded identification number. The key is provided with the code, which is unique to the key in a manner well known in the art. The code is transmitted to a control 30 which is an immobilizer control. If the code is as expected by the control 30, then the operation of the vehicle engine 31 is allowed to start or continue. However, if the code is not as expected by the control 30, then ignition is either not initiated, or is terminated.

The above aspects of an immobilizer system are as known in the art. The present invention, however, utilizes the immobilizer system to provide additional functions. One additional function relates to the elimination of a key switch. Key switches are utilized to provide an indication that the key is in the ignition. This allows a warning signal to be sent should the vehicle door be opened while the key is in the ignition, or if some other status change which is potentially inconsistent with the key still being in the ignition be requested.

Further, the system can periodically look for the key through the control 30 to move to positions consistent with the key being removed, such as tilting the steering wheel away, etc.

The present invention includes a switch 32 for determining that a door 33 is being opened. Should the control 30 receive a signal that the door 33 has been opened, it will transmit a signal to determine whether the key 24 is still in the ignition 22. If so, then a warning signal is sent such as through speaker 38.

In a second embodiment, memory position such as the location of a vehicle seat 34 can be controlled by the control 30 based upon the unique code received from the key 24. Thus, when the control 30 receives the unique code of the key 24, it can identify the particular code with a particular user. Previously stored memory settings of components such as the vehicle seats 34, the mirrors, etc. can then be achieved. The movement and storage can be as known.

While a single control 30 is illustrated as the control associated with the immobilizer, it should also be understood that any grouping of controls to achieve the above discussed functions can be utilized. It is the use of a control for identifying the presence or lack thereof of the key, and the code which is inventive here. Further, while the two above-referenced functions are disclosed in combination, it should also be understood that they have main benefits which are separate and distinct from each other, and this application separately detects each of those functions, or any other functions which come within the scope of the claims.

In summary, various functions can be provided by the immobilizer key code. While preferred embodiments of these functions are disclosed, it should be understood that additional functions may also be achieved. Thus, the claims should be reviewed to determine the true scope and content of this invention.

1. An immobilizer system for a vehicle comprising:
an immobilizer control for receiving a code from an ignition key, said control operating an immobilizer system for immobilizing a vehicle engine, and further controlling another vehicle function;
an ignition key incorporating a transmitter/receiver for transmitting a code to said control; and
said control utilizing the receipt of a code from said key to control said additional vehicle function.

2. A system as recited in claim 1, wherein said code provides an indication of a particular user for actuation of a memory function, and said additional function is moving at least one component to a previously stored position associated with said code.

3. A system as set forth in claim 1, wherein said additional function is the determination of whether the key is in said ignition.

4. A system as set forth in claim 3, wherein a warning signal is sent should a change request be received from a portion of the vehicle it is inconsistent with the key still being in said ignition and a determination is made that said key is still in said ignition by said immobilizer control.

5. A system as set forth in claim 4, wherein said change in status is the opening of the vehicle door.

6. An immobilizer system for a vehicle comprising:
an immobilizer control for receiving a code from an ignition key, said control operating an immobilizer system for immobilizing a vehicle engine, and further controlling another vehicle function;
an ignition key incorporating a transmitter/receiver for transmitting a code to said control; and
said control utilizing the receipt of a code from said key to control said additional vehicle function said additional vehicle function being the movement of vehicle components to memory positions.

7. An immobilizer system for a vehicle comprising:
an immobilizer control for receiving a code from an ignition key, said control operating an immobilizer system for immobilizing a vehicle engine, and further receiving a signal when a signal is received that a vehicle door is opened;
an ignition key incorporating a transmitter/receiver for transmitting a code to said control; and
said control utilizing the receipt of a code from said key to determine that a key is still in an ignition when a signal is received that the vehicle door is open, and then actuating a warning signal.

8. A system as set forth in claim 7, wherein the lack of a key being sensed in an ignition being utilized to move components to an out-of-vehicle position.

9. A system as set forth in claim 8, wherein said components include the steering wheel being tilted away from a use position.

10. A system as set forth in claim 8, wherein said signal is an audio warning signal.

11. An immobilizer system for a vehicle comprising:
an immobilizer control for receiving a code from an ignition key, said control operating an immobilizer system for immobilizing a vehicle engine, and further periodically checking for the presence of a vehicle key in the ignition, said control communicating with another component on the vehicle to move the other component to a non-use position when said control senses that no key is in said ignition.

12. A system as set forth in claim 11, wherein said other component is a vehicle steering wheel which is tilted toward a non-use position.
